(19) United States
(12) Patent Application Publication
(10) Pub. No.: US 2017/0023727 A1
(43) Pub. Date: Jan. 26, 2017

(54) EDGE TYPE BACKLIGHT MODULE AND DISPLAY DEVICE

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Zhishuai Jia, Tianjin (CN); Jinnan Zhang, Tianjin (CN)

(21) Appl. No.: 15/245,050

(22) Filed: Aug. 23, 2016

Related U.S. Application Data
(63) Continuation of application No. PCT/CN2016/087011, filed on Jun. 24, 2016.

(30) Foreign Application Priority Data
Jul. 21, 2015 (CN) 201510431908.2

(51) Int. Cl. F21V 8/00

(52) U.S. Cl. CPC G02B 6/0061; G02B 6/0068; G02B 6/0026

(57) ABSTRACT

Disclosed are an edge type backlight module and a display device. The edge type backlight module includes a light guide plate, a plurality of light sources, and dim area compensating units disposed between two adjacent light sources. Light rays of each light source enter the light guide plate from a lateral side, and by the effect of the light guide plate, light rays go out of the light guide plate from the front face. The dim area compensating units are used for providing light compensation for the dim areas between two light sources. By setting the dim area compensating unit between two light sources, the utility model of the present disclosure discloses an edge type backlight module which solves the dim area effect effectively, thus avoiding defects of the prior art for solving the dim area effect.

### CROSS-REFERENCE TO RELATED APPLICATIONS

The present disclosure is a continuation of International Application No. PCT/CN2016/087011 filed on Jun. 24, 2016, which is based upon and claims priority to Chinese Patent Application No. 201510431908.2, entitled “EDGE TYPE BACKLIGHT MODULE AND DISPLAY DEVICE”, filed on Jul. 21, 2015, the entire contents of all of which are incorporated herein by reference.

### TECHNICAL FIELD

The embodiment of the present disclosure generally relates to the field of display technology, in particular to an edge type backlight module and a display device.

### BACKGROUND

Liquid crystal displays are passive light-emitting components, and need special structure design to obtain light sources, while the backlight module is a device for providing the liquid crystal displays with light sources. The working mode of the backlight modules is that an incident line light source or a spot light source is converted into a uniformly outgoing area light source, wherein the backlight modules can be classified into edge type backlight modules and direct-down type backlight modules according to different locations of the light source. Displays such as TVs and high-brightness monitors are usually thin, light, highly bright, wide in view angle and high in light utilization rate. Such displays usually adopt direct-down type backlight modules. The direct-down type structure does not need a light guide plate, mixes light rays mainly using a reflector box, and then uniformly emits the light rays out. The edge type structure is usually applicable to medium and small-sized backlight modules, and mainly applied to mobile phones, notebook computers, onboard panels, monitors, etc., has light and thin features, etc., but is low in light utilization rate.

For example, a backlight module includes a light source, a reflection layer, a light guide plate, a diffusion film, a prismatic lens, a light enhancing film, etc. The light source enters the light reflector from a lateral side. By the effect of the light guide plate, the light rays are uniformly emitted out from the front face, and by the effects of the prismatic lens and the diffusion film, etc., the light rays are uniformly controlled to go out in a certain angle of view. Wherein, the light guide plate plays a role of changing the transmission direction of the laterally incident light rays of the light source so that a uniform area light source with light rays outgoing from the front side is generated. After light rays enter the light guide plate, total reflection may occur to result in that the light rays cannot go out from the light guide plate. Therefore, the lower surface of the light guide plate is provided with a microstructure of which the scattering process can damage the total reflection conditions of the light rays, and then the light rays can uniformly go out from the front face. The reflection layer plays a role of recycling the light rays, which go out from the lower surface of the light guide plate to improve the utilization rate of the light rays. The diffusion film plays a role of atomizing light rays outgoing from the light guide plate to reduce the difference of the brightness and dimness of the outgoing light rays and further improve the uniformity of the light rays. The prismatic lens re-converge the scattered light rays to improve the brightness of the outgoing light rays.

An LED is used as an edge type backlight module of the light source. The scattering angle of the LED light source is limited, and areas on the light reflector close to the LED light source are bright areas with light columns, so the phenomenon of non-uniform brightness and dimness is generated, namely the Hot Spot phenomenon. In a lateral deflection type LED backlight module, LEDs are linearly arrayed on a light bar PCB at a certain interval. LEDs are not devices emitting light rays uniformly, have the highest light intensity in a certain outgoing angle (about ±50°), and very low light intensity in the rest outgoing angle. For the above two reasons, the composite brightness at positions between two LEDs is less than the brightness in a 0° outgoing angle, thus generating areas with brightness and dimness.

### SUMMARY

In order to effectively solve the Hot Spot phenomenon, namely non-uniform brightness and dimness, an embodiment of the present disclosure discloses an edge type backlight module and a display device.

An embodiment of the present disclosure discloses an edge type backlight module, including: a light guide plate, a plurality of light sources, and dim area compensating units disposed between two adjacent light sources, wherein the light guide plate is used for guiding the light rays, which enter the light guide plate, of each light source to uniformly go out from the front face; and the dim area compensating units are used for providing light compensation for the dim areas between two light sources.

Optionally, according to an embodiment of the present disclosure, the edge type backlight module also includes light bars, and a plurality of light sources is disposed on the light bars.

Optionally, according to an embodiment of the present disclosure, the light bars are disposed in the first direction on a lateral side of the light guide plate.

Optionally, according to an embodiment of the present disclosure, each dim area compensating unit includes a dim area compensating light source, and the dim area compensating light source is disposed in the second direction on a lateral side of the light guide plate.

Optionally, according to an embodiment of the present disclosure, the dim area compensating unit also includes a light source compensating film layer, and each light source compensating film layer is used for deflecting light emitted by the dim area compensating light source to provide light compensation for the dim area between two adjacent light sources.

Optionally, according to an embodiment of the present disclosure, the light source compensating film layer includes a first fluorescent film layer and a second fluorescent film layer; the dim area compensating unit is used for processing light emitted by the dim area compensating light source through the first fluorescent film layer and the second fluorescent film layer to provide light compensation for the dim area between two adjacent light sources.

Optionally, according to an embodiment of the present disclosure, the first fluorescent film layer is disposed below the second fluorescent film layer; the first fluorescent film layer is provided with a cut; the cut is used for guiding the light emitted by the dim area compensating light source to the second fluorescent film layer; and the second fluorescent film layer is used for processing the received light to obtain white light.

Optionally, according to an embodiment of the present disclosure, the first fluorescent film layer includes a first base and a photo quencher layer; and the photo quencher layer is used for absorbing the light rays transmitted via components other than the cut.

Optionally, according to an embodiment of the present disclosure, the second fluorescent film layer includes a first fluorescent powder layer and a second fluorescent powder layer; and the second fluorescent film layer is used for processing light rays transmitted by the cut through the first fluorescent powder layer and the second fluorescent powder layer to generate white light.

Optionally, according to an embodiment of the present disclosure, the second fluorescent film layer also includes a second base, a third base and a fourth base; the first fluorescent powder layer is disposed between the second and third bases; and the second fluorescent powder layer is disposed between the third and fourth bases.

Optionally, according an embodiment of the present disclosure, the dim area compensating light source is a UV light source; the photo quencher layer is a UV photo quencher layer; the first fluorescent powder layer is a blue fluorescent powder layer for generating blue light; the second fluorescent powder layer is a yellow fluorescent powder layer for generating yellow light, or a red and green mixed fluorescent powder layer for generating red light and green light respectively; the second fluorescent powder film is used for generating mixing the yellow light generated by the first fluorescent powder layer and the blue light generated by the second fluorescent powder layer to generate while light; or mixing the yellow light generated by the first fluorescent powder layer and the red light and green light which are respectively generated by the second fluorescent powder layer to generate the white light.

An embodiment of the present disclosure discloses a display device, including the edge type backlight module according to any one of embodiments of the present disclosure.

According to the embodiments of the present disclosure, by setting the dim area compensating unit between two light sources, the light rays of each light source enter the light guide plate from a lateral side, and by the effect of the light guide plate, the light rays uniformly go out of the light guide plate from the front face; the dim area compensating unit is used for providing light compensation for the dim area between two adjacent light sources, thus providing an edge type backlight module for effectively solving the dim area effect and avoiding defects of the prior art for solving the dim area effect.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic view of a plane structure of an edge type backlight module according to a first embodiment of the present disclosure.

FIG. 2 is a structural view of an edge type backlight module according to a second embodiment of the present disclosure.

FIG. 3 is a sectional structural view of a light compensating layer in FIG. 2.

FIG. 4 is a view of flow chart of manufacturing of the dim area compensating unit according to the second embodiment of the present disclosure.

### DETAILED DESCRIPTION

To clarify the above objective, characteristics and advantages of the present disclosure, the present disclosure is described in further detail with reference to the attached drawings and embodiment.

An edge type backlight module according to the following embodiment of the present disclosure can be applied to a smart terminal with a display interface, for example a smart TV, a smart mobile phone and a tablet computer.

According to the embodiments of the present disclosure, by setting the dim area compensating unit between two light sources, the light rays of each light source enter the light guide plate from a lateral side, and by the effect of the light guide plate, the light rays uniformly go out of the light guide plate from the front face; the dim area compensating unit is used for providing light compensation for the dim area between two adjacent light sources, thus providing an edge type backlight module for effectively solving the dim area effect and avoiding defects of the prior art for solving the dim area effect.

FIG. 1 is a schematic view of a plane structure of an edge type backlight module according to one embodiment of the present disclosure. As shown in FIG. 1, The edge type backlight module includes: a light guide plate 101, a plurality of light sources 102, and dim area compensating units 103 disposed between two adjacent light sources 102, wherein the light guide plate 101 is used for guiding the light rays, which enter the light guide plate from a lateral side, of each light source 102 to uniformly go out from the front face; and the dim area compensating units 103 are used for providing light compensation for the dim areas between two light sources 102. Therefore, the light rays of each light source 102 enter the light guide plate 101 from a lateral side, and by the effect of the light guide plate 101, the light rays uniformly go out of the light guide plate 101 from the front face; the dim area compensating unit 103 is used for providing light compensation for the dim area between two adjacent light sources, thus avoiding the hot spot phenomenon, namely non-uniform brightness and dimness.

In this embodiment, the light guide plate 101 is made by from an optical acrylic/PC (Polycarbonate) plate, which is a hi-tech material with extremely high reflectivity and with light absorptivity. The optical acrylic/polycarbonate plate is printed with light guide points on the bottom face by using a UV (ultraviolet) screen printing technology. The optical acrylic plate absorbs light rays emitted from the light and the light rays stay on the surface of the optical-grade acrylic plate. When the light rays reach all light guide points, the reflective light is scattered in all directions, damage the reflection conditions, and then go out of the light guide plate 101 from the front face. Through various light guide points, which are distributed in a disordered way and are different in size, the light rays can uniformly go out of the light guide plate 101 from the front face.

In this embodiment, the light guide plate 101 can be any one of the following types:

Classified by shape: flat plate: the light guide plate 101 is rectangular plate viewed on the incident side. Wedge plate: also called inclined plate, with a thick edge and a thin edge (triangle) viewed in the incident side.

Classified by dot: printed type: after the shape processing of the light guide plate 101 is completed, dots are printed on the reflective face in a printing way. This type is also classified into IR and UV types. Non-printed type: dots are directly formed on the reflective face during the formation of the light guide plate 101. This type is also classified into etching, V-cut, stamper and internal diffusion types.

Classified by forming: jet forming: optical-grade PMMA particles are jetted into a mold at a high temperature and a high pressure by using a jet forming machine, and then cooled to be formed. Cut forming: optical-grade PMMA raw plate is cut into finished products.

In this embodiment, the dim area compensating unit 103 can be LED lights with fluorescent powder, or with different colors. The light rays are processed by using fluorescent in different colors. Red, yellow, green, blue and violet light rays of synthesized to generate the white light, which achieves a backlight effect. LED lights in different colors can be directly manufactured by using fluorescent powder in different colors. Red, yellow, green, blue and violet light rays sent by LED colors in different colors are synthesized to generate the white light, which achieves a backlight effect.

It is needed to be noted that, the embodiment of the present disclosure can also be used for compensating light in a specific color, for example, compensating red light, or compensating yellow light, green light, blue light and violet light. During specific implementation, it is only needed to the fluorescent powder in corresponding color or the LED supported by the fluorescent, so details are not described here.

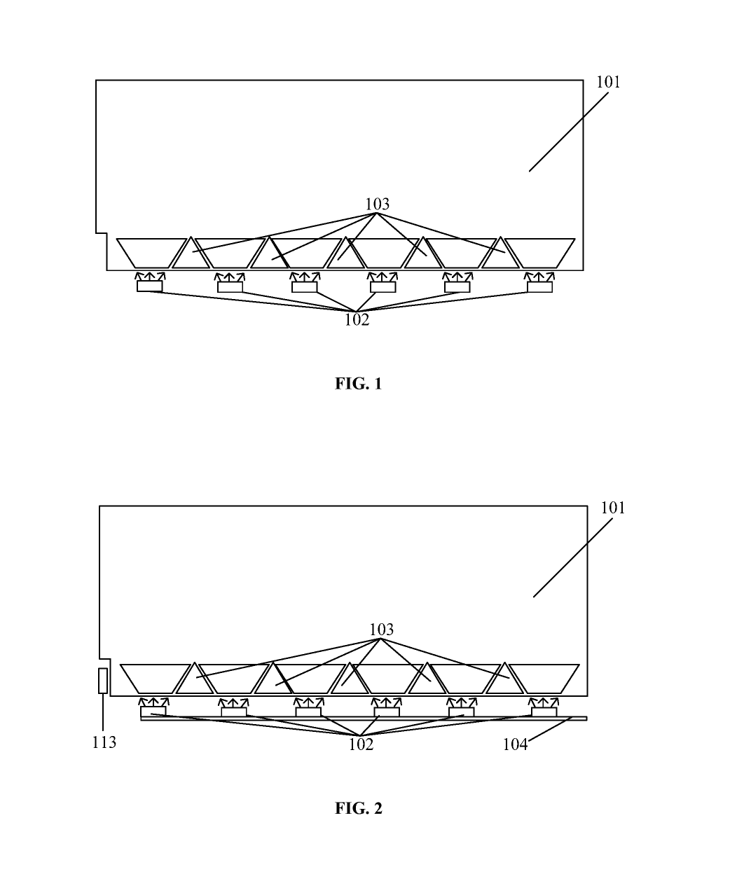

FIG. 2 is a structural view of the edge type backlight module according to another embodiment of the present disclosure. As shown in FIG. 2, the incident backlight module includes a light guide plate 101, a plurality of light sources 102, dim area compensating units 103 and light bars 104 disposed between two adjacent light sources. The plurality of light sources 102 is disposed on the light bars 104, and the light sources may be line light sources or point light sources. Specifically, the light bars 104 are disposed in the first direction on a lateral side of the light guide plate 101.

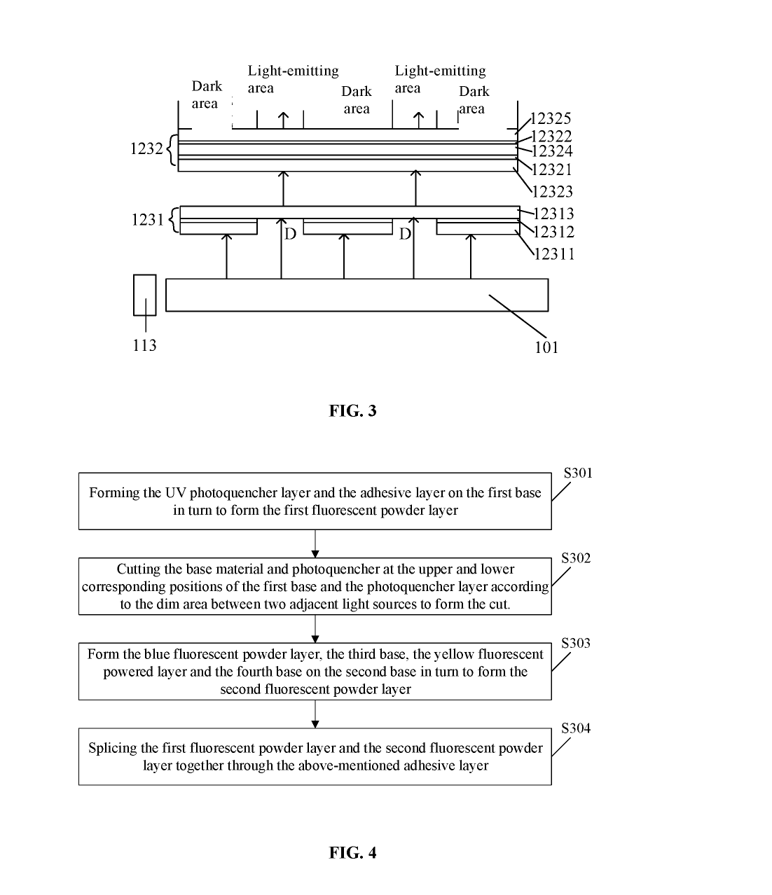

FIG. 3 is a sectional structural view of a light source compensating layer in FIG. 2. As shown in FIG. 3, the dim area compensating unit 103 includes a dim area compensating light source 113, and the dim area compensating light source 113 is disposed in the second direction of the lateral side of the light guide plate 101. The second direction is vertical to the first direction, for example, if the first direction is the horizontal direction, and then the second direction is the vertical direction. It is needed to be noted that, for those ordinarily skilled in this field, in another embodiment, the first direction may be vertical direction, while the second direction be the horizontal direction.

The dim area compensating unit 103 also includes a light source compensating film layer 123, and the light source compensating film layer 123 is used for deflecting light emitted by the dim area compensating light source 113 to provide light compensation to a dim area between two adjacent light sources. Specifically, the light source compensating film layer 123 includes a first fluorescent film layer 1231 and a second fluorescent film layer 1232; the first fluorescent film layer 1231 and the second fluorescent film layer 1232 can co-process the light emitted by the dim area compensating light source 113 to provide light compensation for the dim area between two adjacent light sources.

Optionally, in this embodiment, the first fluorescent film layer 1231 is disposed below the second fluorescent film layer 1232; the first fluorescent film layer 1231 is provided with a cut D; the light emitted by the dim area compensating light source 113 is guided by the cut D to the second fluorescent film layer 1232; and the second fluorescent film layer 1232 is used for processing the received light to obtain white light, thereby forming light rays for compensating the dim area between two adjacent light sources. The size and shape of the cut D are obtained with reference to the shape and size of the dim area.

Optionally, in this embodiment, the first fluorescent film layer 1231 includes a first base 12311 and a photo quencher 12312; the cut D is formed by cutting the base material and photo quencher at upper and lower corresponding positions of the first base 12311 and the photo quencher 12312, namely the cut D obtained by cutting a part of the base material of the first base 12311 and a corresponding part of photo quencher of the photo quencher layer 12312; the photo quencher layer 12312 is used for absorbing and processing the light rays transmitted by components except the cut D, namely partial shielding, so the light rays of the safety compensating light source are transmitted to the second fluorescent film layer 1232 through the cut D only. The cut shapes of the first base 12311 and the photo quencher layer 12312 correspond to the shape of the cut D and the corresponding bright area, for example, the cut D may be triangular, round or other shapes.

Optionally, in this embodiment, the second fluorescent film layer 1232 includes a first fluorescent powder layer 12321 and a second fluorescent powder layer 12322; and the first fluorescent powder layer 12321 and the second fluorescent powder layer 12322 co-process the light rays transmitted by the cut D to generate white light.

Further, in this embodiment, the second fluorescent film layer 1232 also includes a second base 12323, a third base 12324 and a fourth base 12325; the first fluorescent powder layer 12321 is disposed between the second base 12323 and the third base 12324; and the second fluorescent powder layer 12322 is disposed between the third base 12324 and the fourth base 12325. The second base 12323 and the first base 12311 are spliced through an adhesive layer 12313 to integrally assemble the first fluorescent film layer 1231 and the second fluorescent film layer 1232 together.

In this embodiment, the materials of the first base 12311, the second base 12323, the third base 12324 and the fourth base 12325 can be PET or PC base materials.

It is needed to be noted that, in an optional embodiment, the photo quencher layer 12312 is a UV photo quencher layer, while the first fluorescent powder layer 12321 is a blue fluorescent powder layer used for generating blue light; the second fluorescent powder layer 12322 is a yellow fluorescent powder layer used for generating yellow light; directly above the cut D and on the second fluorescent powder layer 12322, the yellow light and the blue light are mixed to generate white light to form a light-emitting area, and other positions are dark areas.

In another optional embodiment, the dim area compensating light source 113 may be a UV photo quencher light source, the photo quencher layer is a UV photo quencher layer, while the first fluorescent powder layer 12321 is a blue fluorescent powder layer used for generating blue light; the second fluorescent powder layer 12322 is a red and green mixed fluorescent powder layer used for generating red and green light respectively; directly above the cut D and on the second fluorescent powder layer 12322, the blue light is mixed with red light and green light are to generate white light to form a light-emitting area, and other positions are dark areas.

FIG. 4 is a flow chart of manufacturing of the dim area compensating unit 103 according to the second embodiment of the present disclosure. As shown in FIG. 4, the manufacturing includes the steps as follows.

S301: Form the UV photo quencher layer and the adhesive layer on the first base in turn to form the first fluorescent powder layer.

Specifically, the first base can be formed with the UV photo quencher layer by such technologies as coating and spray injection, and the UV photo quencher layer is formed with the adhesive layer by technologies of coating and adhesion.

S302: Cut the base material and photo quencher at the upper and lower corresponding positions of the first base and the photo quencher layer according to the dim area between two adjacent light sources to form the cut.

Specifically, the base material and photo quencher at the upper and lower corresponding positions of the first base and the photo quencher layer can be cut by such technologies as tool die cutting to form the cut.

S303: Form the blue fluorescent powder layer, the third base, the yellow fluorescent powered layer and the fourth base on the second base in turn to form the second fluorescent powder layer.

Specifically, the second base can be formed with the blue fluorescent powder layer by such technologies as coating and spray injection; the blue fluorescent powder layer can be formed on the third base by such technologies as fitting and tape casting composition; the third base can be formed with the yellow fluorescent powder layer by such technologies as coating and spray injection; and the yellow fluorescent powder layer can be formed on the fourth base by such technologies such as fitting and tape casting composition.

S304: Splice the first fluorescent powder layer and the second fluorescent powder layer together through the above-mentioned adhesive layer.

An embodiment of the present disclosure discloses a display device, including the edge type backlight module according to any one of the above-mentioned embodiments.

The present disclosure is described with reference to the flow charts and/or block diagrams of the methods and devices (systems) and products of the embodiments of the present disclosure. All embodiments of the present disclosures are described in a progressive manner. Every embodiment focuses on different factors. Identical and similar parts of the embodiments can be reference of one another.

The optimal embodiments of the present disclosure are described, but those skilled in this field can make other changes and modifications on those embodiments when getting the basic creative concept. Therefore, the protection scope of the Claims includes the optimal embodiments and all changes and modifications within the embodiments of the present disclosure.

Finally, it is needed to be noted that, in the text, the relationship terms such as the “first” and the “second” are used for merely distinguishing an entity or operation from another entity or operation, and it is not always required or hinted that the entities or operation have such practical relationships or are in such sequences. Besides, the terms “comprise”, “include” or any other synonyms are intended to cover non-exclusive inclusion, so the processes, methods, articles or terminal devices of a series of elements include not only those elements, but also other elements, which are not clearly listed, or also include all inherent factors of those processes, methods, articles or terminal devices. In the case of no more limit, the elements defined by the sentence “comprising/including a/an . . . ” should not exclude that the processes, methods, articles or terminal devices including the elements also include other identical elements.

The above are detailed description of the edge type backlight module and the display device of the present disclosure. Specific examples are used in the text to describe the principle and implementation mode of the present disclosure. The description of the above embodiments is only used for clarifying the method and essential concepts of the present disclosure. Meanwhile, for those ordinarily skilled in this field, changes may be made to the specific implementation modes and application scope according to the concept of the present disclosure. In conclusion, the contents of the Description cannot be regarded as limit in the present disclosure.

What is claimed is:

1. An edge type backlight module, comprising a light guide plate, a plurality of light sources, and dim area compensating units disposed between two adjacent light sources; wherein,
the light guide plate is used for uniformly emitting light rays, entering of the light guide plate from a lateral side, of each light source, from the front face;
and the dim area compensating units are used for providing light compensation for the dim areas between two adjacent light sources.

2. The edge type backlight module according to claim 1, further comprising light bars, wherein a plurality of light sources are disposed on the light bars.

3. The edge type backlight module according to claim 2, wherein the light bars are disposed in a first direction of a lateral side of the light guide plate.

4. The edge type backlight module according to claim 1, wherein the dim area compensating unit comprises a dim area compensating light source, and the dim area compensating light source is disposed in a second direction of the lateral side of the light guide plate.

5. The edge type backlight module according to claim 4, wherein the dim area compensating unit further comprises a light source compensating film layer, and the light source compensating film layer is used for deflecting light emitted by the dim area compensating light source to provide light compensation for the dim area between two adjacent light sources.

6. The edge type backlight module according to claim 5, wherein the light source compensating film layer comprises a first fluorescent film layer and a second fluorescent film layer;
the dim area compensating unit is used for processing light emitted by the dim area compensating light source through the first fluorescent film layer and the second fluorescent film layer to provide light compensation to a dim area between two adjacent light sources.

7. The edge type backlight module according to claim 6, wherein the first fluorescent film layer is disposed below the second fluorescent film layer; the first fluorescent film layer is provided with a cut;
the cut is used for guiding the light emitted by the dim area compensating light source to the second fluorescent film layer;
and the second fluorescent film layer is used for processing the received light to obtain white light.

8. The edge type backlight module according to claim 7, wherein the first fluorescent film layer comprises a first base and a photo quencher layer;
and the photo quencher layer is used for absorbing the light rays transmitted via components other than the cut.

9. The edge type backlight module according to claim 7, wherein the second fluorescent film layer comprises a first fluorescent powder layer and a second fluorescent powder layer; and the second fluorescent film layer is used for processing light rays transmitted by the cut through the first fluorescent powder layer and the second fluorescent powder layer to generate white light.

10. The edge type backlight module according to claim 9, wherein the second fluorescent film layer also includes a second base, a third base and a fourth base; the first fluorescent powder layer is disposed between the second and third bases; and the second fluorescent powder layer is disposed between the third and fourth bases.

11. The edge type backlight module according to claim 10, wherein the dim area compensating light source is a UV light source, while the photo quencher layer is a UV quencher layer;
the first fluorescent powder layer is a blue fluorescent powder layer for generating blue light;
the second fluorescent powder layer is a yellow fluorescent powder layer for generating yellow light, or a red light and green light mixed fluorescent powder layer used for respectively generating red light and green light;
the second fluorescent powder film is used for generating mixing the yellow light generated by the first fluorescent powder layer and the blue light generated by the second fluorescent powder layer to generate while light; or mixing the yellow light generated by the first fluorescent powder layer and the red light and green light which are respectively generated by the second fluorescent powder layer to generate the white light.

12. A display device, comprising the edge type backlight module according to claim 1.

13. The display device according to claim 12, wherein the edge type backlight module further comprises light bars, a plurality of light sources are disposed on the light bars.

14. The display device according to claim 13, wherein the light bars are disposed in a first direction of a lateral side of the light guide plate.

15. The display device according to claim 12, wherein the dim area compensating unit comprises a dim area compensating light source, and the dim area compensating light source is disposed in a second direction of the lateral side of the light guide plate.

16. The display device according to claim 15, wherein the dim area compensating unit further comprises a light source compensating film layer, and the light source compensating film layer is used for deflecting light emitted by the dim area compensating light source to provide light compensation for the dim area between two adjacent light sources.

17. The display device according to claim 16, wherein the light source compensating film layer comprises a first fluorescent film layer and a second fluorescent film layer;
the dim area compensating unit is used for processing light emitted by the dim area compensating light source through the first fluorescent film layer and the second fluorescent film layer to provide light compensation to a dim area between two adjacent light sources.

18. The display device according to claim 17, wherein the first fluorescent film layer is disposed below the second fluorescent film layer; the first fluorescent film layer is provided with a cut;
the cut is used for guiding the light emitted by the dim area compensating light source to the second fluorescent film layer;
and the second fluorescent film layer is used for processing the received light to obtain white light.

19. The display device according to claim 18, wherein the first fluorescent film layer comprises a first base and a photo quencher layer;
and the photo quencher layer is used for absorbing the light rays transmitted via components other than the cut.

20. The display device according to claim 18, wherein the second fluorescent film layer comprises a first fluorescent powder layer and a second fluorescent powder layer; and the second fluorescent film layer is used for processing light rays transmitted by the cut through the first fluorescent powder layer and the second fluorescent powder layer to generate white light.
